(19) United States
(12) Patent Application Publication
(10) Pub. No.: US 2012/0229336 A1
(43) Pub. Date: Sep. 13, 2012

(54) ANTENNA BEAM DIRECTIVITY APPARATUS AND ANTENNA BEAM DIRECTIVITY METHOD

(76) Inventor: Youichi Koichi, Tokyo (JP)

(21) Appl. No.: 13/513,161

(22) PCT Filed: Nov. 25, 2010
(86) PCT No.: PCT/JP2010/071531

§ 371 Date: May 31, 2012

(30) Foreign Application Priority Data
Dec. 3, 2009 (JP) 2009-275711

(51) Int. Cl. H01Q 3/26

(52) U.S. Cl. 342/373

(57) ABSTRACT

Provided are an antenna beam directivity apparatus and an antenna beam directivity method by which directivity accuracy of the antenna beam can be improved without adding a large scale device.

The antenna beam directivity apparatus, having an array power feeding system, is provided with: input signal vector generating means for generating an input signal vector based on an input signal; weight vector holding means for holding a weight vector; weight correcting means for correcting the weight vector based on a value of an inner product of the input signal vector and the weight vector, so that the value of the inner product becomes a first value for a reference signal; and beam forming means for forming a null beam in a direction of the reference signal.

### TECHNICAL FIELD

The present invention relates to an antenna beam directivity apparatus and an antenna beam directivity method, an in particular, to an antenna beam directivity apparatus and an antenna beam directivity method, which is mounted on a satellite on an orbit, equipped with a reflecting mirror antenna having a phased array power feeding system, and corrects an error in directivity of the antenna beam.

### BACKGROUND ART

In recent years, with upsizing of a mounted reflecting mirror and increasing a frequency of a reflection electromagnetic wave beam, a beam width of the antenna beam becomes narrower. Furthermore, according to an error in attitude control for the satellite and a factor of thermal deformation of the antenna reflecting mirror, or the like. mulfunction caused by the error in the antenna beam directivity direction becomes more remarkable. For example, for a radio wave sent from a communication satellite on an orbit, electric field strength on the ground sometimes decreases, then the reception and transmission capacities of the satellite for a service area decrease. Thereby, reduction of communication quality occurs.

An antenna reflecting mirror mounted on the communication satellite is becoming larger (a level of 20 meters to a level of 30 meters). Accordingly, since the width of the antenna beam becomes further narrower, the above-mentioned tendency is expected to be more remarkable.

In a related art, in order to avoid the above-mentioned reduction of communication quality, a drive mechanism has been installed in the antenna reflecting mirror, then the antenna beam direction has been corrected by the drive mechanism. However, this method requires a complicated and expensive reflecting mirror drive mechanism, and enlarges the satellite.

In the correcting method of the other related art, attitude error information, which an attitude sensor has, is inputted into a satellite, then the satellite corrects an antenna beam directivity direction using the attitude error information. However, in this method, the directivity error by the antenna itself cannot be recognized. Furthermore, the satellite must be equipped with a high precision attitude sensor, then the satellite becomes complicated and expensive.

Patent literature 1 discloses a control method and a control apparatus, which performs adaptive control for a main beam in a direction of a desired wave signal so as to form null in a direction of an interference wave signal, and does an array antenna. That is, calculating a covariance matrix of the array antenna maximizing a received signal vector using the expectation value maximizing method; calculating weights for performing the adaptive control for the main beam in the direction of the desired wave signal so as to form null in the direction of the interference wave signal using the covariance matrix; calculating symbol estimate values using the weight; and repeating calculation for reconstructing the received signal vector using the symbol estimate values, and repeating formation of the main beam in which interference in the same channel is suppressed.

Patent literature 2 discloses a directivity control method of an array antenna for updating weight coefficients based on an error between the antenna signal and the known reference signal; and performing correction based on error information.

Patent literature 3 discloses a directivity error compensating method and an apparatus thereof of an array power feeding reflecting mirror multi-beam antenna for compensating a directivity direction error of the multi-beam antenna. That is, the designation direction error compensating apparatus calculates boresight direction error components and scaling factor variation components of the reflecting mirror from receiving levels or transmitting levels of beams at different geographical positions of three or more; calculates a phase shift quantity for each of the antenna elements which compose the array power feeding unit from the calculated scaling factor variation components; and calculates a phase shift quantity, which compensates the designation direction error, from a phase shift quantity which compensates a boresight variation component and a phase shift component which compensates a scaling factor component. The phase shift quantity for the designation direction error is provided to an output from a multi beam forming apparatus.

### CITATION LIST

[Patent Literature]

[Patent Literature 1] Japanese Patent Application Laid-Open No. 2005-252694

[Patent Literature 2] PCT International Publication No. WO 2006/126247

[Patent Literature 3] Japanese Patent Application Laid-Open No. 2006-242752

### SUMMARY OF INVENTION

### Technical Problem

However, the antenna beam directivity apparatus and the directivity method for antenna beam of the above-mentioned related art have problems that the mounted reflecting mirror becomes larger, the frequency of the reflecting electromagnetic wave beam becomes higher, the beam width of the antenna beam is narrow, an error in the attitude control of the satellite exists, the antenna reflecting mirror thermally deforms, and the like. According to them, an error occurs in the antenna beam directivity direction.

Furthermore, according to the error in the attitude control of the communication satellite, the electric field strength of the radio wave sent from the communication satellite on the orbit decreases, and the reception and transmission capacities of the satellite for the service area decrease. As a result, the communication quality declines. Moreover, the antenna reflecting mirror mounted on the communication satellite is becoming larger (a level of 20 meters to a level of 30 meters), then the width of the antenna beam becomes narrower. For this reason, this tendency is expected to become remarkable in the future.

Furthermore, the method of correcting the antenna beam direction by means of the driving mechanism installed in the antenna reflecting mirror requires a complicated and expensive mechanism for driving the reflecting mirror. For this reason, this method has a problem that the satellite becomes larger.

The method of correcting the antenna beam directivity direction by using the attitude error information, which the attitude sensor has. Furthermore, this method requires a high precision attitude sensor mounted on the satellite. As a result, this method has a problem that the satellite becomes complicated and more expensive.

Patent literature 1 discloses the processing for avoiding an interference of channel by plural antenna elements, but does not describe the processing for correcting the directivity direction of the beam into the reference direction taking account of the error. Accordingly, the directivity direction of the antenna beam is not controlled in a high precision.

Patent literature 2 discloses the processing for updating weight coefficients taking account of a movement of the target, but there is not an operation of referring to the reference direction, and the state unstable with respect to the increasing error cannot be dealt with.

In the directivity error compensating method, disclosed by Patent literature 3, detecting the reception levels of beams at three spots or more is needed. Accordingly, operation time and memory capacity for processing plural signals becomes necessary, and the apparatus becomes inevitably larger.

The present invention has been achieved in view of the problem of technology of the above-mentioned related art, and has an object to provide an antenna beam directivity apparatus and a control method thereof, which enhance the directivity accuracy of the antenna beam without requiring a command from the ground and without adding a complicated and high-cost equipment.

### Solution to Problem

In order to solve the above-mentioned problem, an antenna beam directivity apparatus according to the present invention is characterized by including: input signal vector generating means for generating an input signal vector by an input signal; weight vector holding means for holding a weight vector; weight correcting means for correcting the weight vector based on a value of an inner product of the input signal vector and the weight vector, so that the value of the inner product is equal to a first value for a reference signal; and a beam forming unit, which forms a null beam in a direction of the reference signal.

In order to solve the above-mentioned problem, an antenna beam directivity method according to the present invention is an antenna beams directivity method by an antenna beam directivity apparatus equipped with an array power feeding system, characterized by including: a step of generating an input signal vector by an input signal; a step of correcting the weight vector based on a value of an inner product of the input signal vector and the weight vector, so that the value of the inner product is equal to a first value for a reference signal; and a step of forming a null beam in a direction of the reference signal.

### Advantageous Effects of Invention

According to the antenna beam directivity apparatus of the present invention, in the antenna beam directivity apparatus equipped with the reflection mirror antenna having the phased array power feeding system, high directivity accuracy is obtained without requiring the command from the ground and without adding a complicated and high-cost equipment.

### BRIEF DESCRIPTION OF DRAWINGS

FIG. 1 is a block diagram showing an overall configuration of the antenna beam directivity apparatus according to an exemplary embodiment of the present invention;

FIG. 2 is a drawing illustrating a processing of the antenna beam directivity apparatus according to the exemplary embodiment of the present invention;

FIG. 3 is a drawing showing a detailed configuration of the antenna beam directivity apparatus according to the exemplary embodiment of the present invention;

FIG. 4 is an explanatory drawing showing a processing for resetting eight coefficients; and

FIG. 5 is an explanatory drawing showing a relation between the antenna directivity direction and the beacon arrival direction.

### DESCRIPTION OF EMBODIMENTS

Hereinafter, an antenna beam directivity apparatus and an antenna beam directivity method according to the present invention will be described in detail referring to the drawings.

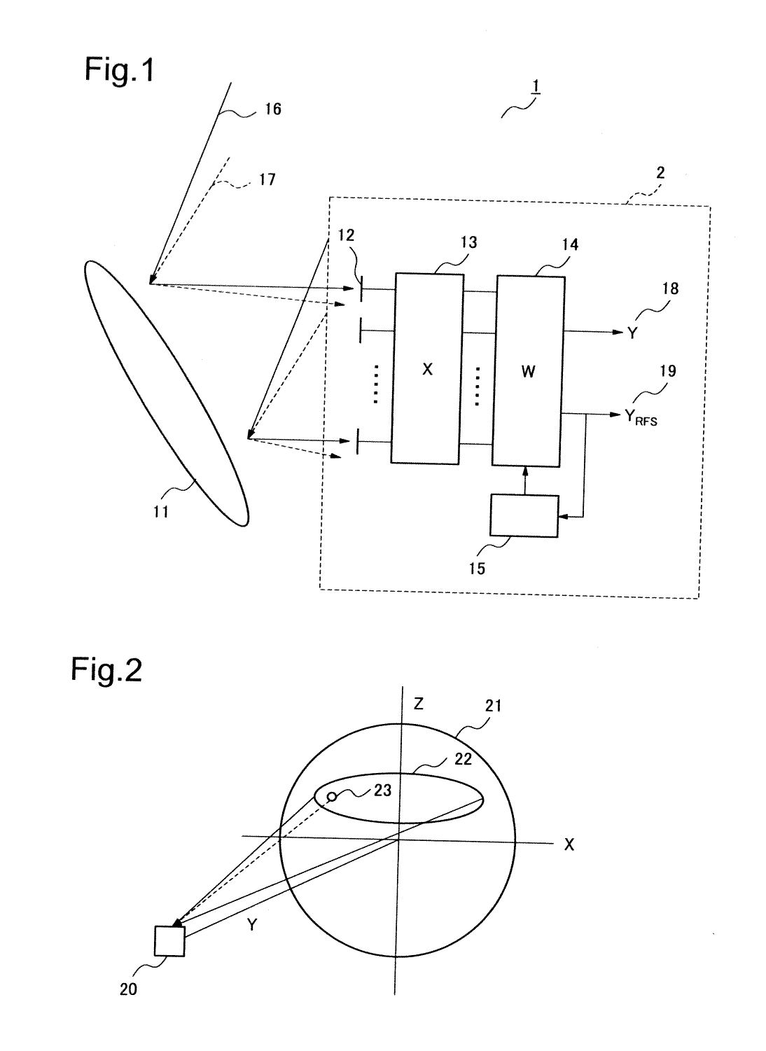

FIG. 1 is a block diagram showing an overall configuration of the antenna beam directivity apparatus according to an exemplary embodiment of the present invention.

In FIG. 1, the antenna beam directivity apparatus according to the present exemplary embodiment includes a reflecting mirror 11, a radiating element 12, an input signal forming unit 13, a weight giving unit 14 and a weight coefficient regenerating circuit 15. In FIGS. 1, 16, 17, 18 and 19 indicate an input signal, an input signal after deviation from the beam directivity, an occurrence signal output of the beam Y (received signal power), and a beacon signal power Y_{RFS} (null signal occurrence signal output), respectively. The weight giving unit 14 gives weight to each radiating element 12.

Hereinafter, an example of a processing in the antenna beam directivity apparatus according to the present exemplary embodiment will be described.

The input signal forming unit 13 forms an input signal vector including as a component an electric signal generated in the plural radiating elements 12. The weight giving unit 14 gives a weight set for each radiating element 12 to the component of the input signal vector. By these processings, the beam is formed. Hereinafter, this processing will be described.

Here, a weight vector generated in the input signal forming unit 13 is X, and a weight vector given in the weight giving unit 14 is W.

Then, the occurrence signal output of the beam Y is expressed by an inner product of these vectors, X and W. Meanwhile, in a multibeam system, there are occurrence signal outputs of the beam Y exists as many as the number of the beams.

Here, forming of the null beam in the reference beacon direction is considered. The null beam has a large gain difference for an angle change compared with the usual beam, has a high angular resolution, and is used for setting the directivity direction with a high precision. For example, the null beam generates four multibeams in two dimensions, and is generated by an anti-phase synthesis of four multibeams.

The null beam directing without an error in the reference direction from the input signal of the beacon signal means that the inner product of the vector generated from the input signal of the beacon signal in the input signal forming unit 13 and the weight vector given in the weight giving unit 14 is zero.

A value of the signal detected by the antenna beam directivity apparatus according to the present example, that is, the occurrence signal output of the beam Y is zero.

Then, the weight coefficient, that is, the weight vector, which the weight giving unit 14 gives, is the weight coefficient, which forms the null pattern is formed for the arrival direction of the input signal.

An error in posture control of the satellite and influence from thermal deformation of the reflecting mirror appear in a change in the direction of the input signal. That is, a value of the component of the vector, which the input signal forming unit 13 generates, changes. In this case, the weight, which the weight giving unit 14 gives, is corrected (reconstructed) so that the null beam directs in the reference direction from the input signal of the beacon signal, i.e. the inner product of the vector, which the input signal forming unit 13 generates, and the weight vector is zero. As a result, a weight coefficient, in which a deviation in the directivity direction is compensated, is regenerated. This null beam is different from beams for other communications, and is not limited to use for communications.

Next, an operation in the antenna beam directivity apparatus according to the exemplary embodiment of the present invention will be described.

A processing, which generates the occurrence signal output of the beam Y 18, is calculating the inner product of the input signal vector and the weight vector, described as above. This calculation is a calculation with the input signal and the weight coefficient. Accordingly, even if the number of beams or the number of radiating elements increases, it is adaptable only by increasing the number of dimension of the vector. That is, an extension of scale of the equipment is small.

In an actual operation, the reference signal from the RF sensor (RFS) being given, the control is performed so that a difference between a signal output R of this and the inner product of the input signal vector and the weight vector is minimized. The beacon signal power Y_{RFS} 19, generated from an input signal received from a ground station, an installation site of which is grasped in advance, is inputted into the weight coefficient reconfiguration circuit 15, as a null beam output, in order to minimize the magnitude of the signal output. The weight coefficient reconfiguration circuit 15 updates (reconstructs) a weight coefficient based on information on deviation from the directivity direction included in the signal output. Reconfiguring the weight coefficient corresponds to a change in a phase component of the component of the weight vector.

FIG. 2 is an explanatory drawing illustrating a processing in the antenna beam directivity apparatus according to the exemplary embodiment of the present invention.

FIG. 2 indicates a fixed satellite 20, which mounts the antenna beam directivity apparatus according to the exemplary embodiment of the present invention, the earth 21 and a beacon transmitting station 23 on the ground. Meanwhile, a radiation range of the antenna is the area indicated by 22 on the earth 21.

Beam directivity accuracy in the attitude control system of the satellite is 0.1 to 0.2 degrees. In contrast, in recent years, a directivity accuracy required for the satellite beam is no more than 0.05 degrees. In the case where the reflecting mirror is enlarged, this requirement becomes severer, no more than 0.03 degrees. Accordingly, improvement of the directivity accuracy is indispensable.

The array power feeding system is designed so as to cover the radiation range 22. The array power feeding system has a high gain for a position of the beacon transmitting station 23 on the ground included in the radiation range 22. A null beam is formed without adding an antenna. The error in the posture control of the satellite is generally the largest around the yaw axis (Y axis), and the larger an angle of view to the radiation range 22 is, the greater the influence of error is. In the example shown in FIG. 2, the beacon station on the ground beacon is only one, but two or more stations on the ground may generally be arranged.

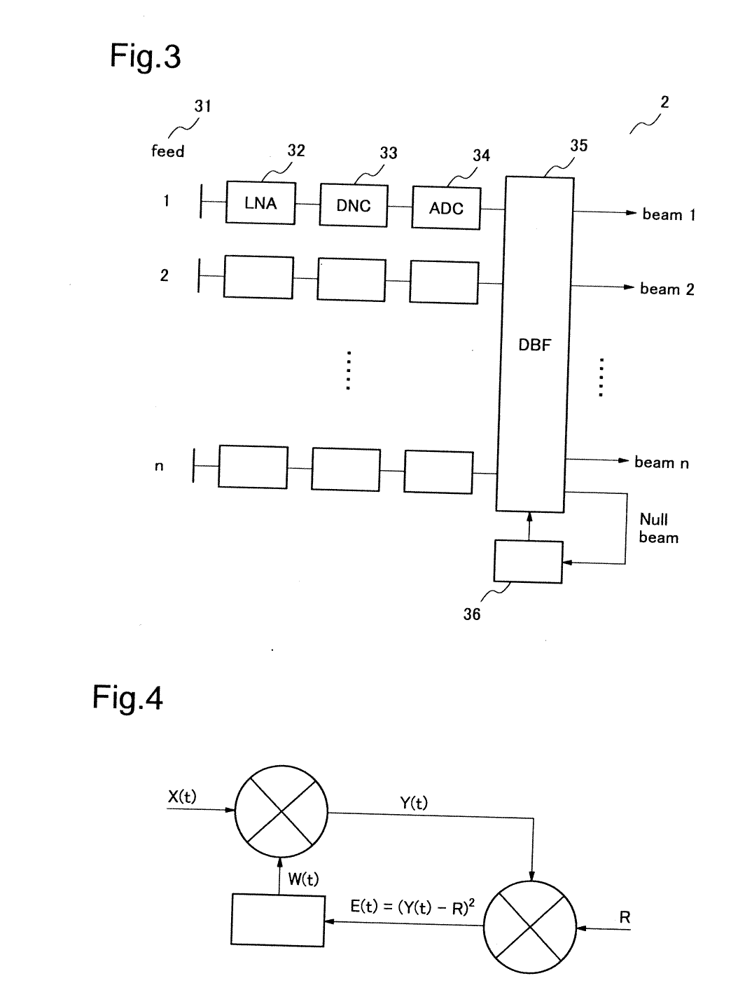

FIG. 3 is a block diagram illustrating an example of configuration of equipment in detail and a mounting of the antenna beam directivity apparatus according to the exemplary embodiment of the present invention.

In FIG. 3, the power feeding unit includes a receiving element (feed) 31, a low noise amplifier (LNA) 32, a down converter (DNC) 33, an analog digital converter (ADC) 34, a digital beam forming (DBF) circuit 35, and a weight coefficient regenerating circuit 36.

Calculation of the input signal vector generated by the input signal forming unit 13 and the weight vector given in the weight giving unit 14 is performed in the digital beam forming circuit 35. The digital beam forming circuit 35 generates plural beams simultaneously (multibeam formation).

In the beam forming by the digital beam forming circuit 35, a null beam in the direction to the beacon station is generated.

By the generated null beam, the reference signal is received. The received signal is inputted, and a null beam output is obtained. A direction of the formed beam is corrected based on the output of the null beam, as described in the following.

When the null beam directs to a beacon station, the output of the null beam is zero, as above. However, according to posture of the satellite or the thermal deformation the reflecting mirror, when the null beam deviates from the beacon station direction, a two-dimensional error signal occurs. When this error signal is detected, the null beam signal and the usual beam signal are detected. The null beam signal is normalized by the usual beam signal. As a result, it is identified whether the beacon signal falls or the error signal falls.

FIG. 4 is an explanatory drawing illustrating a closed loop of a processing for reconfiguring the weight coefficient by digital processing.

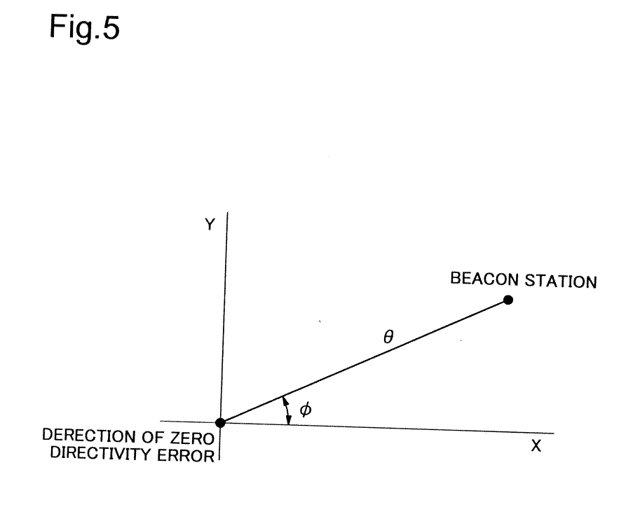

FIG. 5 is an explanatory drawing illustrating a relation between the antenna directivity direction and the beacon arrival direction.

When the arrival direction of the beacon wave deviates from the antenna directivity direction, the error signal occurs, as described above. When the deviation in the directivity direction increases, the detection signal becomes larger. Furthermore, the higher error sensitivity is, the larger the detection signal is. The directivity direction is specified by each of two components included in the two-dimensional error signal. The error signal is converted by the weight coefficient regenerating circuit 36 into a changed value of the phase component of the weight coefficient. As a result, change is performed so that the deviation from the directivity direction of the multibeam becomes small.

In FIG. 4, the weight vector W before correction is generated inside the beam forming processor. The weight vector W does not depend on time, when it is not corrected. The fixed beam is generated, based on the weight vector W. A phase variance part (θ) is considered for the weight vector W(t) in the case of being corrected by the error. The dependency on the phase variance part (θ) for the weight vector W(t) is, for example, W(t)=W·exp(i θₙ). Here, θₙ is expressed by 2·π·d·n·sin φ/λ. θₙ is a phase rotation component of the weight coefficient of the n-th radiating element, counting from the reference radiation element. Furthermore, d is an interval distance between the radiation elements, φ is a directivity direction angle viewed from the power feeding unit, and λ is a wavelength of the signal. The directivity direction deviation is corrected according to this relation, and the null signal generation signal output Y_{RFS} is minimized. Meanwhile, the weight coefficient after the correction does not correct the directivity direction separately for each of the plural beams. The weight coefficient modifies (corrects), for the multibeam, the directivity direction of the beam direction all at once.

Furthermore, φ is the beam directivity angle viewed from the power feeding unit, and in the case of having the reflecting mirror, the beam is reflected by the reflecting mirror, and a beam (the secondary pattern) is generated in a desired direction. Therefore, φ is different from the beam directivity direction of the antenna. However, a change in the beam direction viewed from the power feeding unit has a unique relation with a change in the last beam direction (the secondary pattern) when the shape of the reflecting mirror is fixed. For this reason, a beam is generated in a direction desired by the whole antenna, by generating the phase variance part.

The above processing is repeated until the deviation of the directivity direction of the null beam falls within an allowable range.

Next, control of operation of a digital processing step closed loop will be described.

As shown in FIG. 4, by the inner product of the input vector X(t) and the weight coefficient W(t) for the null signal formation, signal output Y(t) is calculated. The input vector X(t) and weight coefficient W(t) for the null signal formation depend on time, t, respectively. Meanwhile, the time t is a parameter for indicating a temporal variation of the weight coefficient.

Here, as an error amount e(t), assume a square of a difference between the detection signal, which is expressed as the inner product of the weight coefficient, generating the RF sensor beam, and the input vector in the reference signal direction from the ground, and the reference signal. That is, by e(t)=(R−Y(t))², the error amount is obtained.

By taking variation for this error amount, a differential equation for the weight coefficient W(t) is derived.

In the operation of the digital processing step closed loop, shown in a FIG. 4, according to the differential equation, control is performed so that the error component e(t) becomes zero.

The weight coefficient, on the actual digital circuit, includes a time difference, and is sequentially updated at every sampling time.

According to the antenna beam directivity apparatus of the present invention, by adding a simple calculation function, correction for the beam directivity direction on the orbit is performed. That is, as shown in FIG. 3, without adding a special equipment, simple vector calculation function has only to be added to an arithmetic processor in the established beam forming apparatus. For example, adding the specific antenna for estimating the antenna beam arrival direction, the mechanism for correcting the directivity of the antenna beam, the phase shifter for varying the phase plane of the radio wave, or the like becomes unnecessary. Accordingly, the cost of the apparatus is suppressed.

Meanwhile, in the present exemplary embodiment, in FIG. 3, the weight coefficient is applied to the reception antenna, but in the transmitting antenna, the beam directivity direction may be corrected simultaneously with the reception antenna.

In the present exemplary embodiment, the example, in which the present invention is applied to the antenna of the phased array power feeding unit type using the reflecting mirror, is shown, the method of the present invention may also be applied to an phased array antenna of the directly radiating type.

The present invention has been described with reference to the exemplary embodiment, but the present invention is not limited to the above-mentioned exemplary embodiment. Various modifications, which a person skilled in the art can understand in the scope of the present invention, can be performed in forms and details of the present invention.

This application is based upon and claims the benefit of priority from Japanese Patent Application No. 2009-275711, filed Dec. 3, 2009, the disclosure of which is incorporated herein in its entirety by reference.

### INDUSTRIAL APPLICABILITY

The present invention can be applied to an antenna beam directivity apparatus. In particular, the present invention can be preferably applied to an antenna beam directivity apparatus, which has a reflection mirror antenna having a phased array power feeding system and corrects directivity error on the orbit. Furthermore, the present invention is practicable as a method for correcting a directivity direction of an antenna beam used on a fixed satellite.

### REFERENCE SIGNS LIST

1 ANTENNA BEAM DIRECTIVITY APPARATUS

2 POWER FEEDING UNIT

11 REFLECTING MIRROR

12,31 RADIATING ELEMENT

13 INPUT SIGNAL VECTOR

14 WEIGHT VECTOR

15 WEIGHT COEFFICIENT REGENERATING CIRCUIT

16 INPUT SIGNAL

17 INPUT SIGNAL AFTER DEVIATION FROM BEAM DIRECTIVITY

18 RECEIVED SIGNAL POWER

19 BEACON SIGNAL OUTPUT

20 FIXED SATELLITE

21 THE EARTH

22 SERVICE AREA (EXAMPLE)

23 BEACON GROUND STATION

32 LOW NOISE RECEIVER

33 FREQUENCY CONVERTER

34 AD CONVERTER

35 DIGITAL BEAM FORMING CIRCUIT

36 WEIGHT COEFFICIENT REGENERATING CIRCUIT

1. An antenna beam directivity apparatus, equipped with an array power feeding system, comprising:
input signal vector generating means for generating an input signal vector by based on an input signal;
weight vector holding means for holding a weight vector;
weight correcting means for correcting said weight vector based on a value of an inner product of said input signal vector and said weight vector, so that said value of said inner product becomes a first value for a reference signal; and
a beam forming means for forming a null beam in a direction of said reference signal.

2. The antenna beam directivity apparatus according to claim 1, wherein
a reference signal by said formed null beam is received, and
said weight correcting means generates an error component based on an inner product of an input signal vector generated by said reference signal and the weight vector and said first value, and corrects said weight vector so that said error component becomes zero.

3. The antenna beam directivity apparatus according to claim 1, wherein
said weight correcting means corrects said weight vector by changing a phase of a component of said weight vector.

4. The antenna beam directivity apparatus according to claim 3, wherein
a beam is generated, a direction of said beam being controlled by changing the phase of the component of said weight vector.

5. An antenna beam directivity method in an antenna beam directivity apparatus equipped with an array power feeding system, comprising:
generating an input signal vector based on an input signal;
correcting said weight vector based on a value of an inner product of said input signal vector and said weight vector, so that said value of said inner product becomes a first value for a reference signal; and
forming a null beam in a direction of said reference signal.

6. The antenna beam directivity method according to claim 5, further comprising:
receiving a reference signal by said formed null beam; and
generating an error component based on an inner product of an input signal vector generated by said reference signal and the weight vector and said first value; and
correcting said weight vector so that said error component becomes zero.

7. The antenna beam directivity method according to claim 5, wherein
said weight vector is corrected by changing a phase of a component of said weight vector.

8. The antenna beam directivity method according to claim 7, further comprising
generating a beam, a direction of said beam being controlled by changing the phase of the component of said weight vector.

9. An antenna beam directivity apparatus, equipped with an array power feeding system, comprising:
an input signal vector generating unit that generates an input signal vector based on an input signal;
a weight vector holding unit that holds a weight vector;
a weight correcting unit that corrects said weight vector based on a value of an inner product of said input signal vector and said weight vector, so that said value of said inner product becomes a first value for a reference signal; and
a beam forming unit that forms a null beam in a direction of said reference signal.

10. The antenna beam directivity apparatus according to claim 9, wherein
a reference signal by said formed null beam is received, and
said weight correcting unit generates an error component based on an inner product of an input signal vector generated by said reference signal and the weight vector and said first value, and corrects said weight vector so that said error component becomes zero.

11. The antenna beam directivity apparatus according to claim 9, wherein
said weight correcting unit corrects said weight vector by changing a phase of a component of said weight vector.

12. The antenna beam directivity apparatus according to claim 11, wherein
a beam is generated, a direction of said beam being controlled by changing the phase of the component of said weight vector.

13. The antenna beam directivity apparatus according to claim 2, wherein
said weight correcting means corrects said weight vector by changing a phase of a component of said weight vector.

14. The antenna beam directivity method according to claim 6, wherein
said weight vector is corrected by changing a phase of a component of said weight vector.
